(19) United States
(12) Patent Application Publication
(10) Pub. No.: US 2026/0153383 A1
(43) Pub. Date: Jun. 4, 2026

(54) LOOP INTERFEROMETER FOR PASSIVE STATE OF LIGHT PREPARATION

(71) Applicant: Technology Innovation Institute - Sole Proprietorship LLC, Masdar City, Abu Dhabi (AE)

(72) Inventors: Yury Kurochkin, Abu Dhabi (AE); James Grieve, Abu Dhabi (AE)

(73) Assignee: Technology Innovation Institute - Sole Proprietorship LLC, Masdar City, Abu Dhabi (AE)

(21) Appl. No.: 18/734,634

(22) Filed: Jun. 5, 2024

Related U.S. Application Data
(60) Provisional application No. 63/508,518, filed on Jun. 16, 2023.

(51) Int. Cl. G01J 11/00; G06F 7/58

(52) U.S. Cl. CPC G01J 11/00; G06F 7/588

(57) ABSTRACT

A loop interferometer system including a laser, an optical loop, a beam splitter optically coupled to the laser and the optical loop, and a controller configured to control the laser to generate random phase pulses. The optical loop may be configured to receive the random phase pulses from the laser, time delay the random phase pulses, and direct the time delayed random phase pulses to the beam splitter. The beam splitter may be configured to create output optical pulses from an interference pattern between the random phase pulses from the laser and the time delayed random phase pulses from the optical loop.

### CROSS-REFERENCE TO RELATED APPLICATION

This application claims priority to U.S. Provisional Application Ser. No. 63/508,518, filed Jun. 16, 2023, which is incorporated by reference in its entirety.

### FIELD

A system and method for a loop interferometer for passive state of light preparation.

### BACKGROUND

Light based applications (e.g., telecommunication and Lidar applications) often require random light modulation. Examples of applications utilizing such modulation are Quantum Key distribution (QKD) and random signal lidar. Solutions for implementing these applications often require complex and costly active phase or amplitude light modulators in addition to random number generators to define the state of the light modulation.

While passive light modulation using the randomness of the natural phase diffusion in the laser have been proposed, these solutions are complex. Typically, these solutions require multiple high quality lasers and complex interferometers to generate identical pulses.

### SUMMARY

In one aspect, the present disclosure relates to a loop interferometer system including a laser, an optical loop, a beam splitter optically coupled to the laser and the optical loop, and a controller configured to control the laser to generate random phase pulses. The optical loop may be configured to receive the random phase pulses from the laser, time delay the random phase pulses, and direct the time delayed random phase pulses to the beam splitter. The beam splitter may be configured to create output optical pulses from an interference pattern between the random phase pulses from the laser and the time delayed random phase pulses from the optical loop.

In embodiments of this aspect, the disclosed system according to any one of the above example embodiments, wherein the output optical pulses have a random amplitude corresponding to the interference pattern between the random phase pulses and the time delayed random phase pulses from the optical loop.

In embodiments of this aspect, the disclosed system according to any one of the above example embodiments can include a polarization rotating element integrated within the optical loop rotating a polarization of the time delayed random phase pulses, wherein the output optical pulses have a random polarization corresponding to the interference pattern between the random phase pulses and the time delayed random phase pulses with rotated polarization from the optical loop.

In embodiments of this aspect, the disclosed system according to any one of the above example embodiments, wherein a physical dimension of the optical loop corresponds to a time delay between the random phase pulses from the laser to provide time synchronization of the interference pattern between the random phase pulses from the laser and the time delayed random phase pulses from the optical loop.

In embodiments of this aspect, the disclosed system according to any one of the above example embodiments, wherein the optical loop is an enclosed optical fiber or optical guide formed in a loop configuration having a loop length.

In embodiments of this aspect, the disclosed system according to any one of the above example embodiments, wherein the optical loop is a free-space optical path of mirrors formed in a loop configuration having a loop length.

In embodiments of this aspect, the disclosed system according to any one of the above example embodiments can include a measurement device configured to measure a random amplitude or random polarization of the output optical pulses, wherein the controller may be configured to control operation of the laser or an opto-electrical conversion device based on the measured random amplitude or random polarization of the output optical pulses.

In embodiments of this aspect, the disclosed system according to any one of the above example embodiments, the controller may be configured to determine usability of the output optical pulses by comparing the output optical pulses to application states, output the output optical pulses when the comparison indicates that the interference is usable, and discard the output optical pulses when the comparison indicates that the interference is unusable.

In embodiments of this aspect, the disclosed system according to any one of the above example embodiments, the controller may be configured to provide the output optical pulses to an application circuit.

In embodiments of this aspect, the disclosed system according to any one of the above example embodiments can include an opto-electrical conversion device configured to: convert the output optical pulses into digitized random bits or analogous electrical signals, and provide the digitized random bits or the analogous electrical signals to an application circuit.

In one aspect, the present disclosure relates to a loop interferometry method including controlling, by a controller, a laser to generate random phase pulses, receiving, by an optical loop and a beam splitter, the random phase pulses. The beam splitter is optically coupled to the laser and the optical loop. The method also includes time delaying, by the optical loop, the random phase pulses from the laser, directing, by the optical loop, the time delayed random phase pulses to the beam splitter, and creating, by the beam splitter, output optical pulses from an interference pattern between the random phase pulses from the laser and the time delayed random phase pulses from the optical loop.

In embodiments of this aspect, the disclosed method according to any one of the above example embodiments can include creating, by the beam splitter, the output optical pulses having a random amplitude corresponding to the interference pattern between the random phase pulses and the time delayed random phase pulses from the optical loop.

In embodiments of this aspect, the disclosed method according to any one of the above example embodiments can include rotating, by a polarization rotating element integrated within the optical loop, a polarization of the time delayed random phase pulses, wherein the output optical pulses have a random polarization corresponding to the interference pattern between the random phase pulses and the time delayed random phase pulses with rotated polarization from the optical loop.

In embodiments of this aspect, the disclosed method according to any one of the above example embodiments can include time delaying, by the optical loop, the random phase pulses from the laser by guiding the random phase pulses through a length of the optical loop corresponding to a time delay between of the random phase pulses from the laser to provide time synchronization of the interference pattern between the random phase pulses from the laser and the time delayed random phase pulses from the optical loop.

In embodiments of this aspect, the disclosed method according to any one of the above example embodiments can include guiding, by the optical loop, the random phase pulses through an enclosed optical fiber or optical guide of the optical loop having a loop length.

In embodiments of this aspect, the disclosed method according to any one of the above example embodiments can include guiding, by the optical loop, the random phase pulses through a free-space optical path of mirrors formed in a loop configuration having a loop length.

In embodiments of this aspect, the disclosed method according to any one of the above example embodiments can include measuring, by a measurement device, a random amplitude or random polarization of the output optical pulses, and controlling, by the controller, an operation of the laser or an opto-electrical conversion device based on the measured random amplitude or random polarization of the output optical pulses.

In embodiments of this aspect, the disclosed method according to any one of the above example embodiments can include determining, by the controller, usability of the output optical pulses by comparing the output optical pulses to application states, outputting, by the controller, the output optical pulses when the comparison indicates that the interference is usable, and discarding, by the controller, the output optical pulses when the comparison indicates that the interference is unusable.

In embodiments of this aspect, the disclosed method according to any one of the above example embodiments can include providing, by the controller or the beam splitter, the output optical pulses as random optical pulses to an application circuit.

In embodiments of this aspect, the disclosed method according to any one of the above example embodiments can include converting, by an opto-electrical conversion device, the output optical pulses into digitized random bits or analogous electrical signals, and providing, by the opto-electrical conversion device, the digitized random bits or the analogous electrical signals to an application circuit.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 shows a block diagram of an interferometer system, according to an example embodiment of the present disclosure.

FIG. 2A shows a fiber-optic loop interferometer for generating signals with random amplitude, according to an example embodiment of the present disclosure.

FIG. 2B shows a fiber-optic loop interferometer for generating signals with random polarization, according to an example embodiment of the present disclosure.

FIG. 3A shows a free-space loop interferometer for generating signals with random amplitude, according to an example embodiment of the present disclosure.

FIG. 3B shows a free-space loop interferometer for generating signals with random polarization, according to an example embodiment of the present disclosure.

FIG. 4 shows a block diagram of hardware of the controller of the interferometer system or hardware of the application device, according to an example embodiment of the present disclosure.

FIG. 5 shows a flowchart for operation of the interferometer system, according to an example embodiment of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The disclosed methods, devices and systems herein overcome the limitations of existing systems by implementing a passive state of light preparation system. In a process referred to as phase diffusion, the system generates random light (i.e., laser beam) phase states due to spontaneous emission when the laser is periodically turned ON and OFF. In other words, each time the laser is turned ON, a random phase laser beam is emitted due to the quantum effects of the laser emission. The system uses these random light phase states to create interference patterns that produce random light amplitude states and/or random light polarization states. More specifically, these random light states are produced in a passive manner by way of interference patterns between successive laser pulses emitted from the laser.

The system generally includes one or more lasers, a loop interferometer to generate the random amplitude and/or random polarization light states, and a beam splitter to provide the random light states to a measurement device and to an application device for use in various applications. The measurement device measures the random light states to determine utilization of the random light states by the application device. It is noted that the loop interferometer may include a beam splitter and an optical loop embodied by optical fiber, waveguides, a free-space optical path or any combination thereof. The optical loop has dimensions (e.g., a length) that introduces a time delay and potentially a rotation of polarization of the incoming light. With the use of the beam splitter, the optical loop then creates random light states based on an interference pattern between the light pulse that traveled through the loop and a newly incoming light pulse into the beam splitter. In other words, the optical loop causes an interference between a first light pulse having a random phase and a subsequent second light pulse having another random phase, thereby producing a resultant light pulse with random amplitude and/or random polarization for use by the application device.

Practical applications of the disclosed methods, devices and systems herein include but are not limited to Quantum Key Distribution (QKD) and Random Modulation Light Detection and Ranging (Lidar). QKD, for example, is a secure communication protocol that generates a cryptographic key based on quantum states. In QKD, two or more entities may generate and share a quantum state generated cryptographic key for use in symmetric key cryptography. The quantum state generated cryptographic key may be generated by a pulsed laser having random phase, polarization and/or amplitude. Random Modulation Lidar is a distancing application that uses a pulsed laser with random amplitude to measure distances between a laser transmitter and the target by way of interference patterns. The random states of light form unique patterns which are easily distinguishable from light patterns emitted by other Lidar systems. In other words, multiple Random Modulation Lidar systems may operate in vicinity to one another without crosstalk (i.e., misinterpreting one Lidar signal for another). This may be beneficial, for example, for Lidar applications executed by vehicles on a busy roadway.

Benefits of the disclosed methods, devices and systems include but are not limited to decreased complexity in optical design and electronic circuitry. In one example, the solution may be implemented using a single laser being turned ON/OFF to output random phase laser pulses, and a single loop interferometer outputting random amplitude and/or random polarization laser pulses. The disclosed methods, devices and systems present a simplified and cost-effective solution for passively generating light pulses with random states.

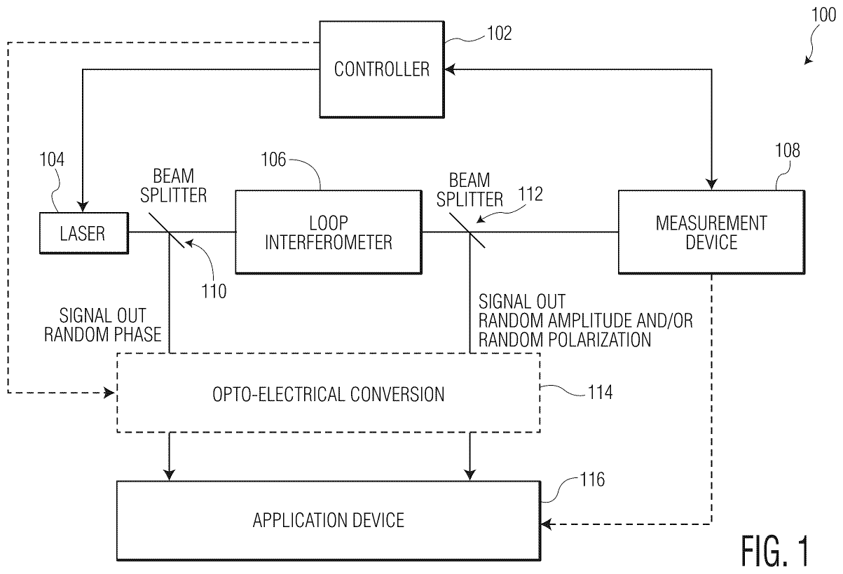

FIG. 1 shows an overall block diagram of an interferometer system 100. The interferometer system includes laser 104, loop interferometer 106, light state measurement device 108, controller 102, beam splitters 110 and 112, and optional opto-electrical conversion device 114 coupled to application device 116. During operation, laser 104 is turned ON/OFF to generate laser pulses. For example, laser 104 may be periodically turned ON/OFF to generate laser pulses having a random phase due to the quantum state of laser light spontaneously emitted each time laser 104 is turned ON. In other words, each time laser 104 is turned ON, the laser oscillator enters a quantum random state in terms of emission phase which results in a laser pulse of random phase. In one example, the laser may be periodically turned ON/OFF at a rate that produces pulses of light having a pulse period of Tp at a pulse rate of 1/Tp, or pairs of pulses separated by time delay Tp and arbitrary time delay between pairs. In addition, the pulses of light may take on any random phase state between 0°-360°.

The random phase laser pulses may be directly output to application device 116 via beam splitter 110 if laser pulses with random phase are desired by application device 116. In addition, the laser pulses with the random phase are emitted through beam splitter 110 and input to loop interferometer 106. Although not shown in FIG. 1, loop interferometer 106 includes an optical loop and a beam splitter for generating an interference pattern between successive laser pulses. In general, a first laser pulse with the random phase generated by the laser 104 is input to loop interferometer 106, travels through the interferometer beam splitter and then through the optical loop. The first laser pulse then travels through the same interferometer beam splitter a second time after a time delay due to traveling through the optical loop. This time delay may be determined based on the speed of light through the medium of the optical loop and the overall length of the optical loop. At the time the first laser pulse travels through the interferometer beam splitter the second time, a second laser pulse with the random phase subsequently generated by laser 104 also travels through the interferometer beam splitter. This causes an interference pattern between the time delayed first laser pulse and the subsequent second laser pulse. Since the first and second pulses have random phases relative to one another, the first and second pulses interfere to produce a resultant laser pulse having a random amplitude.

It is noted that the optical loop may also include a polarization rotator (not shown in FIG. 1) which rotates the first laser pulse as it travels through the optical loop. As the first laser pulse with rotated polarization interferes with the second laser pulse in the interferometer beam splitter, this produces a resultant laser pulse having random polarization. In either case, subsequent laser pulses are generated by the laser and periodically input to the loop interferometer to generate additional resultant pulses. For example, a third pulse may be generated and input to the loop interferometer, such that the third pulse interferes with the second pulse after the second pulse travels through the optical loop. In other words, the first pulse travels through the loop and interferes with the second pulse to produce a resultant pulse with random amplitude or random polarization, then the second pulse travels through the loop and interferes with the third pulse to produce another resultant pulse with random amplitude or random polarization, and so on. This process of generating pulses, delaying the pulses and creating interference patterns with subsequent pulses is repeated such that the system periodically generates and outputs laser pulses with random amplitude or random polarization that can be used by the application device. As mentioned above, the pulses may be generated in pairs, where each pair of pulses creates an interference pattern that produces a random amplitude or random polarization pulse. The timing between each pair may be arbitrary or may be based on various factors including but not limited to avoiding interference between interference patterns of subsequent pairs, output pulse rate desired by the application, etc.

The random amplitude/polarization laser pulse output by loop interferometer 106 may be output to measurement device 108 and/or application device 116 via beam splitter 112. Measurement device 108 in conjunction with controller 102 may decide whether or not the random amplitude/polarization laser pulse should be utilized or not by application device 116. In other words, the measurement device 108 in conjunction with controller 102 may compare the random amplitude/polarization laser pulses to known random amplitude/polarization states that are desired by application device 116. Measurement device 108 and/or controller 102 may control the application device 116 to utilize desirable pulses and discard other undesirable pulses. Discarding of pulses can be performed in hardware by discarding electrical or optical signals representing the pulses, or in software by discarding logical values representing the pulses. Application device 116 may then utilize the desirable pulses in particular applications such as QKD and Lidar as described above.

In another example, interferometer system 100 may optionally convert the laser pulses into electrical signals and/or digital data prior to providing output to the application device 116. For example, opto-electrical conversion device 114 may include light receivers such as photodiodes (not shown) that convert the laser pulses into analog electrical signals. Opto-electrical conversion device 114 may also include an analog-to-digital converter (ADC) (not shown) for converting the analog electrical signals into digital data. In either case, the analog electrical signals and/or digital data representing the analog electrical signals may be used by application device 116. Converting the pulses into analog electrical signals or digital data allows application device 116 to manipulate the amplitude, phase or polarization information inherent in the laser pulses. This may be beneficial for some applications.

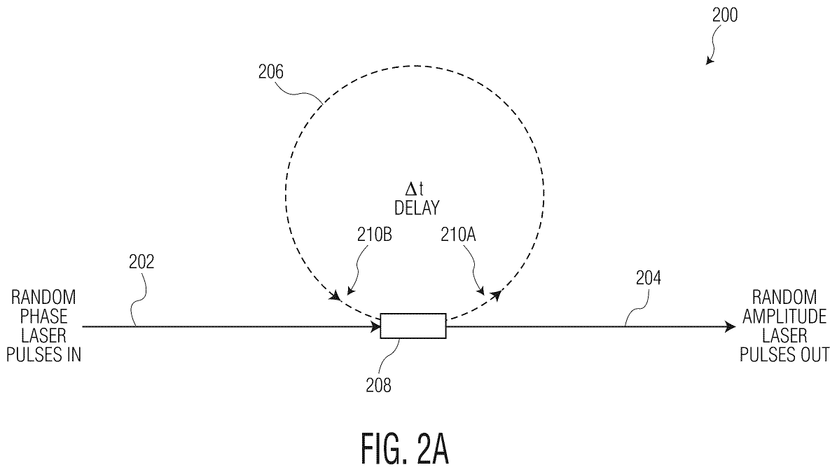

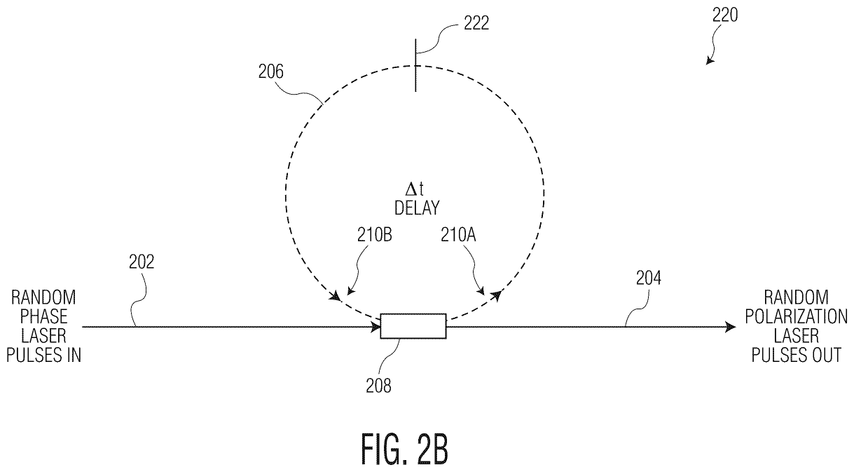

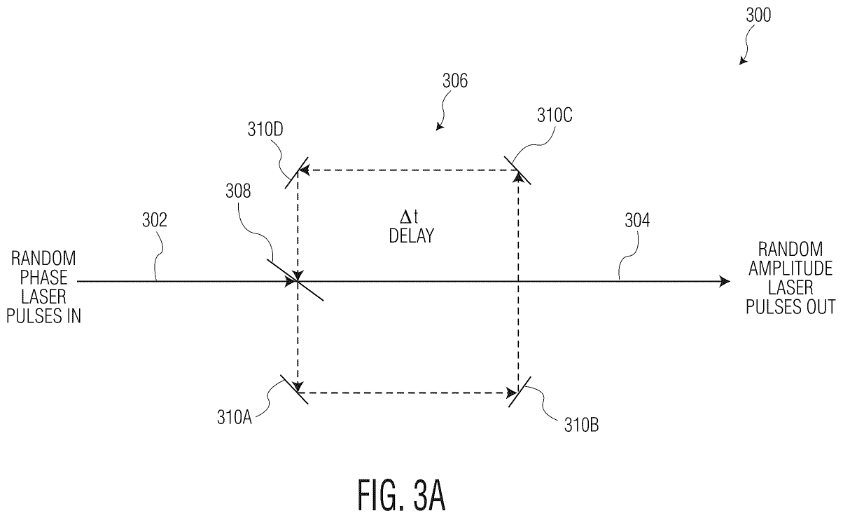

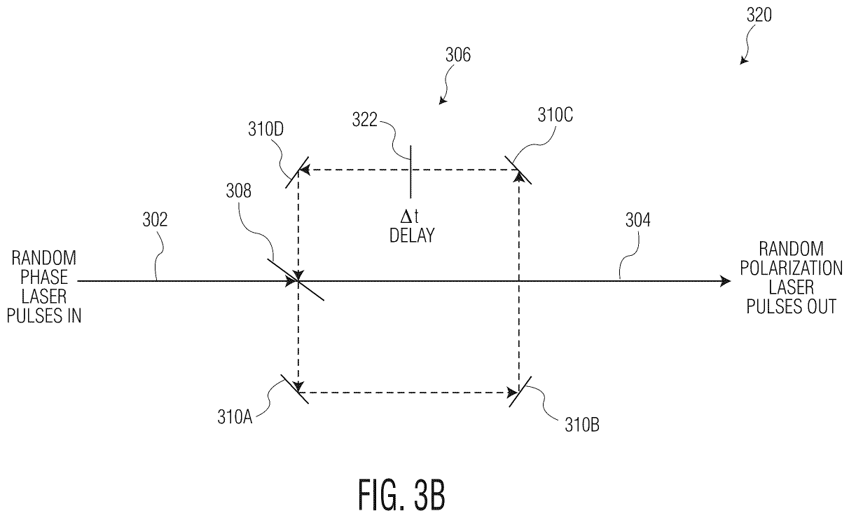

As mentioned above, loop interferometer 106 includes an optical loop, beam splitter and an optional polarization rotator integrated into the loop. Loop interferometer 106 may be implemented in various mediums including a closed optical loop (e.g., optical fiber, waveguides, etc.), a free-space optical loop (e.g., mirrors, etc.) or a combination thereof. Various examples of loop interferometer 106 are described below with respect to FIGS. 2A, 2B, 3A and 3B.

FIG. 2A shows a fiber-optic loop interferometer 200 for generating signals with random amplitude. Fiber-optic loop interferometer 200 includes input optical path 202 (e.g., fiber-optic cable) optically coupled to laser 104, output optical path 204 (e.g., fiber-optic cable) optically coupled to measurement device 108, beam splitter 208 and optical loop 206 embodied by a fiber-optic cable bent in the shape of a loop (e.g., circle, ellipse, etc.).

During operation, a first laser pulse generated by the laser travels through input optical path 202, through beam splitter 208 and enters optical loop 206 via loop input path 210A. The first laser pulse travels through optical loop 206, exits optical loop 206 after a known time delay Δt dictated by the speed of light in the medium of the optical loop and the length of the loop, and then enters beam splitter 208 a second time via loop output path 210B. As the time delayed first laser pulse enters beam splitter 208 for the second time, a second laser pulse generated by the laser and input via optical path 202 also enters beam splitter 208. The time delayed first laser pulse and the second laser pulse are time synchronized so that they interfere to produce a resultant laser pulse having a random amplitude which is then output from beam splitter 208 via output optical path 204. This process is repeated for additional laser pulses generated by the laser to periodically produce resultant laser pulses having a random amplitude on output optical path 204.

It is noted that the physical dimension (e.g., length) of optical loop 206 and time delay between subsequent laser pulses on input optical path 202 are chosen to coincide such that subsequent pulses are time synchronized upon entering the beam splitter. In other words, a subsequent pulse is generated by the laser with a time delay such that the subsequent pulse traveling through input optical path 202 reaches beam splitter 208 at the same time the previous pulse traveling through optical loop 206 reaches beam splitter 208. The time delay between generated laser pulses takes into account time delay Δt introduced by optical loop 206. In addition, each pulse may have the same pulse duration. This ensures that the pulses enter the beam splitter at the same time and have the same duration to ensure an interference pattern having a duration equivalent to the pulse duration.

FIG. 2B shows a fiber-optic loop interferometer 220 for generating signals with random polarization. In addition to the same components shown in FIG. 2A, fiber-optic loop interferometer 220 in FIG. 2B includes a polarization rotator 222. As discussed above, the first laser pulse travels through input optical path 202, through beam splitter 208 and enters optical loop 206 via loop input path 210A. The first laser pulse travels through optical loop 206, where the pulse polarization is rotated by R° by the polarization rotator 222, which then exits optical loop 206 after time delay Δt and enters beam splitter 208 via loop output path 210B. As the time delayed first laser pulse enters beam splitter 208, the second laser pulse from input optical path 202 also enters beam splitter 208. The time delayed first laser pulse and the second laser pulse interfere to produce a resultant laser pulse having a random polarization that is output on output optical path 204. The random polarization of the resultant laser pulse is due to the differences in phase between the first laser pulse and the second laser pulse. For example, if laser 104 outputs vertically polarized laser pulses and the polarization rotator 222 rotates the vertically polarized laser pulses to horizontally polarized laser pulses, interference occurs between the horizontally polarized first laser pulse and the vertically polarized second laser pulse. Since the first laser pulse and second laser pulse also have random phases with respect to one another, the system produces a resultant laser pulse with a resultant polarization based on relative contributions (cross-polarization) of the vertical/horizontal polarizations as weighted by their respective random phases. Again, this process is repeated for additional laser pulses to periodically produce resultant laser pulses having a random polarization on output optical path 204. As noted above, the length of optical loop 206 and time delay between subsequently generated laser pulses on input optical path 202 are chosen to coincide such that the pulses exiting the loop and the subsequent pulses entering the beam splitter 208 are time synchronized to produce an interference pattern.

As described above, optical loop 206 is embodied by an optical fiber. However, optical loop 206 may be embodied by a free-space optical loop that utilizes other optical devices such as mirrors for redirecting the laser pulses over a set loop distance. For example, FIG. 3A shows free-space loop interferometer 300 for generating signals with random amplitude. Free-space loop interferometer 300 includes input optical path 302 (e.g., free-space) optically coupled to laser 104, output optical path 304 (e.g., free-space) optically coupled to measurement device 108, beam splitter 308 and optical loop 306 embodied by a free-space optical loop comprised of mirrors 310A, 310B, 310C and 310D. During operation, the first laser pulse travels through input optical path 302, through beam splitter 308 and enters optical loop 306 traveling towards mirror 310A. The first laser pulse travels through optical loop 306 by reflecting from mirror 310A to mirror 310B to mirror 310C and then to mirror 310D. The pulse exits optical loop 306 after time delay Δt and then enters beam splitter 308. As the time delayed first laser pulse enters beam splitter 308, a second laser pulse from input optical path 302 also enters beam splitter 308. The time delayed first laser pulse and the second laser pulse interfere to produce a resultant laser pulse having a random amplitude that is output on output optical path 304. Again, this process is repeated for additional laser pulses to periodically produce resultant laser pulses having a random amplitude on output optical path 304.

It is noted that the length of optical loop 306 (i.e., length from beam splitter 308 through the path dictated by the mirrors and back to beam splitter 308) and the time delay between subsequent laser pulses on input optical path 302 are chosen to coincide such that subsequent pulses are time synchronized. In other words, the next pulse is generated by the laser with a time delay such that the next pulse traveling through input optical path 302 reaches beam splitter 308 at the same time the previous pulse traveling through optical loop 306 reaches beam splitter 308. The time delay between generated laser pulses effectively takes into account time delay Δt introduced by optical loop 306 to ensure an interference pattern between subsequent pulses.

FIG. 3B shows a free-space loop interferometer 320 for generating laser pulses with random polarization. In addition to the components shown in FIG. 3A, FIG. 3B shows that free-space loop interferometer 320 may also include a polarization rotator 322. As discussed above, the first laser pulse travels through input optical path 302, through beam splitter 308 and enters optical loop 306. The first laser pulse travels through optical loop 306, has its polarization rotated by R° by polarization rotator 322, exits optical loop 306 after time delay Δt and enters beam splitter 308. As the time delayed first laser pulse enters beam splitter 308, the second laser pulse from input optical path 302 also enters beam splitter 308. The time delayed first laser pulse and the second laser pulse interfere to produce a resultant laser pulse having a random polarization that is output on output optical path 204. The random polarization of the resultant laser pulse is due to the differences in phase between the first laser pulse and the second laser pulse. For example, if laser 104 outputs vertically polarized laser pulses and the polarization rotator 322 rotates the vertically polarized laser pulses to horizontally polarized laser pulses, interference occurs between the horizontally polarized first laser pulse and the vertically polarized second laser pulse. Since the first laser pulse and second laser pulse also have random phases with respect to one another, the system produces a resultant laser pulse with a resultant polarization based on relative contributions (cross-polarization) of the vertical/horizontal polarizations as weighted by their respective random phases. Again, this process is repeated for additional laser pulses to periodically produce resultant laser pulses having a random polarization on output optical path 304.

In FIGS. 2A-3B, it is described that a pulse interferes with a subsequent pulse to produce an output pulse that is output to an application device. It should be noted, however, that these output pulses may repeatedly re-enter and re-exit the optical loops 206/306 via beam splitters 208/308 thereby producing subsequent residual output pulses. In other words, the interference pattern created by the initial pair of interfering pulses is not only output from the system as an output pulse, but the generated interference pattern enters and exits the optical loop multiple times until the intensity of the light eventually dissipates and becomes negligible. These residual output pulses may be utilized as additional output pulses or may be discarded depending on the application. In addition, these residual output pulses may or may not interfere with and therefore influence subsequent laser pulses generated by the laser and input to the loop interferometer. Interference of residual output pulses with subsequent pulses may not be an issue for certain applications such as Lidar. In these instances, interference of subsequent pulses with the residual output pulses is allowed to occur. However, interference of subsequent pulses with the residual output pulses may be unwanted in certain applications such as QKD. In these instances, interference of subsequent pulses with the residual output pulses may be avoided, for example, by varying the time between subsequent pulses such that the subsequent pulses do not directly align with the residual output pulses as they pass through the beam splitter.

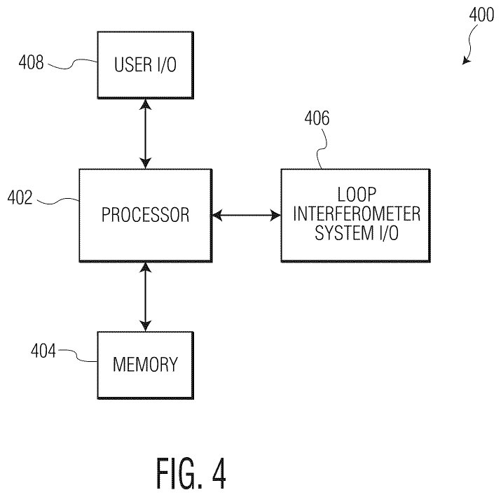

FIG. 4 shows a block diagram of 400 of a processor system that may represent the hardware present in interferometer controller 102 and/or hardware present in random number application device 116. Controller 102 and random number application device 114 may generally include a processor 402, memory device 404, loop interferometer input/output (I/O) interface 406 and user I/O interface 408.

In one example, processor 402 of controller 102 may control the operation of laser 104 and measurement device 108 via interface 406 according to computer code stored in memory device 404, and/or user input received via user I/O interface 408. Processor 402 may, for example, control laser 104 and measurement device 108 such that loop interferometer system 100 outputs laser pulses with random amplitude or random polarization to application device 116 via I/O interface 406.

In another example, processor 402 of random number application device 116 may control its operation based on laser pulses with random amplitude or random polarization received via loop interferometer I/O interface 406 according to computer code stored in memory device 404, and/or user input received via user I/O interface 408. Processor 402 may, for example, perform QKD or Lidar applications based on the received laser pulses.

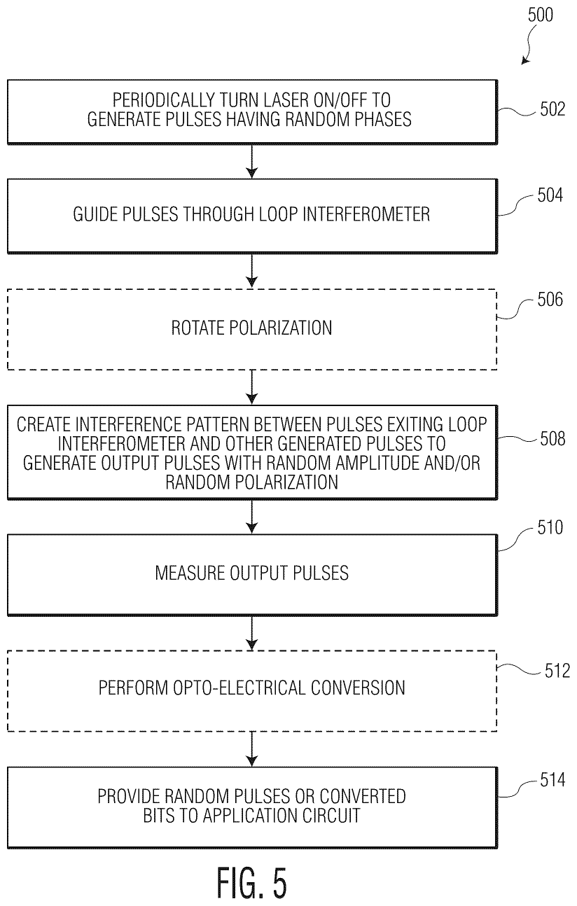

FIG. 5 shows a flowchart 500 for operation of the interferometer system 100. In step 502, the controller periodically turns ON/OFF laser 104 to generate laser pulses with random phase, a set pulse duration and a set pulse rate. In step 504, the generated laser pulses are guided through the loop interferometer 106. In step 506, loop interferometer 106 optionally rotates the polarization of the input laser pulses using a polarization rotator (e.g., 222/322). In step 508, beam splitter (e.g., 208/308) of loop interferometer 106 creates an interference pattern between the laser pulse that traveled through the loop interferometer and a new laser pulse generated by laser 104 and input to loop interferometer 106. This interference pattern is a resultant laser pulse having random amplitude and optionally having a random polarization. In step 510, measurement device 108 measures the resultant laser pulse to determine if the resultant laser pulse should be utilized or not by the application device. For example, measurement device 108 and/or controller 102 could compare the amplitude or random polarization of the resultant laser pulse to acceptable amplitudes and/or polarizations. If the resultant laser pulse is determined to be utilized, then the resultant laser pulse is either provided directly to application device 116 in step 514 or is optionally converted to an electrical signal or digital data in step 512 by opto-electrical conversion device 114 prior to being provided to application device in step 514.

It is noted that the random amplitude or random polarization of the resultant interference pattern pulses can have amplitude (i.e., intensity) values in set ranges based on the capabilities of the laser and optical devices. Furthermore, although the generated pulses have constant amplitude, it is noted that the amplitude of the resultant interference pattern pulse may vary across the pulse duration. In other words, due to constructive and deconstructive interference, the amplitude of the resultant interference pattern pulse may not be constant across the pulse duration. Likewise, the polarization of the laser pulses may have a polarization within a range (e.g., 0°-360°). The resultant interference pattern may also have a polarization in the range (e.g., 0°-360°).

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A loop interferometer system comprising:
a laser;
an optical loop;
a beam splitter optically coupled to the laser and the optical loop; and
a controller configured to control the laser to generate random phase pulses,
wherein the optical loop is configured to receive the random phase pulses from the laser, time delay the random phase pulses, and direct the time delayed random phase pulses to the beam splitter, and
wherein the beam splitter is configured to create output optical pulses from an interference pattern between the random phase pulses from the laser and the time delayed random phase pulses from the optical loop.

2. The system of claim 1, wherein the output optical pulses have a random amplitude corresponding to the interference pattern between the random phase pulses and the time delayed random phase pulses from the optical loop.

3. The system of claim 1, further comprising:
a polarization rotating element integrated within the optical loop rotating a polarization of the time delayed random phase pulses,
wherein the output optical pulses have a random polarization corresponding to the interference pattern between the random phase pulses and the time delayed random phase pulses with rotated polarization from the optical loop.

4. The system of claim 1, wherein a physical dimension of the optical loop corresponds to a time delay between the random phase pulses from the laser to provide time synchronization of the interference pattern between the random phase pulses from the laser and the time delayed random phase pulses from the optical loop.

5. The system of claim 1, wherein the optical loop is an enclosed optical fiber or optical guide formed in a loop configuration having a loop length.

6. The system of claim 1, wherein the optical loop is a free-space optical path of mirrors formed in a loop configuration having a loop length.

7. The system of claim 1, further comprising:
a measurement device configured to measure a random amplitude or random polarization of the output optical pulses,
wherein the controller is further configured to control operation of the laser or an opto-electrical conversion device based on the measured random amplitude or random polarization of the output optical pulses.

8. The system of claim 1, wherein the controller is further configured to:
determine usability of the output optical pulses by comparing the output optical pulses to application states,
output the output optical pulses when the comparing indicates that the interference is usable, and
discard the output optical pulses when the comparing indicates that the interference is unusable.

9. The system of claim 1, wherein the controller is further configured to provide the output optical pulses to an application circuit.

10. The system of claim 1, further comprising:
an opto-electrical conversion device configured to:
convert the output optical pulses into digitized random bits or analogous electrical signals, and
provide the digitized random bits or the analogous electrical signals to an application circuit.

11. A loop interferometry method comprising:
controlling, by a controller, a laser to generate random phase pulses;
receiving, by an optical loop and a beam splitter, the random phase pulses, wherein the beam splitter is optically coupled to the laser and the optical loop;
time delaying, by the optical loop, the random phase pulses from the laser;
directing, by the optical loop, the time delayed random phase pulses to the beam splitter; and
creating, by the beam splitter, output optical pulses from an interference pattern between the random phase pulses from the laser and the time delayed random phase pulses from the optical loop.

12. The method of claim 11, further comprising:
creating, by the beam splitter, the output optical pulses having a random amplitude corresponding to the interference pattern between the random phase pulses and the time delayed random phase pulses from the optical loop.

13. The method of claim 11, further comprising:
rotating, by a polarization rotating element integrated within the optical loop, a polarization of the time delayed random phase pulses,
wherein the output optical pulses have a random polarization corresponding to the interference pattern between the random phase pulses and the time delayed random phase pulses with rotated polarization from the optical loop.

14. The method of claim 11, further comprising:
time delaying, by the optical loop, the random phase pulses from the laser by guiding the random phase pulses through a length of the optical loop corresponding to a time delay between of the random phase pulses from the laser to provide time synchronization of the interference pattern between the random phase pulses from the laser and the time delayed random phase pulses from the optical loop.

15. The method of claim 11, further comprising:
guiding, by the optical loop, the random phase pulses through an enclosed optical fiber or optical guide of the optical loop having a loop length.

16. The method of claim 11, further comprising:
guiding, by the optical loop, the random phase pulses through a free-space optical path of mirrors formed in a loop configuration having a loop length.

17. The method of claim 11, further comprising:
measuring, by a measurement device, a random amplitude or random polarization of the output optical pulses; and
controlling, by the controller, an operation of the laser or an opto-electrical conversion device based on the measured random amplitude or random polarization of the output optical pulses.

18. The method of claim 11, further comprising:
determining, by the controller, usability of the output optical pulses by comparing the output optical pulses to application states;
outputting, by the controller, the output optical pulses when the comparing indicates that the interference is usable; and
discarding, by the controller, the output optical pulses when the comparing indicates that the interference is unusable.

19. The method of claim 11, further comprising:
providing, by the controller or the beam splitter, the output optical pulses as random optical pulses to an application circuit.

20. The method of claim 11, further comprising:
converting, by an opto-electrical conversion device, the output optical pulses into digitized random bits or analogous electrical signals; and
providing, by the opto-electrical conversion device, the digitized random bits or the analogous electrical signals to an application circuit.
